(19) United States
(12) Patent Application Publication
(10) Pub. No.: US 2026/0259626 A1
(43) Pub. Date: Sep. 3, 2026

(54) CLOCK SYNCHRONIZATION USING PERIODIC EXTERNAL REFERENCE CALIBRATION

(71) Applicant: STMicroelectronics International N.V., Geneva (CH)

(72) Inventors: Yannick Guedon, Singapore (SG); John Julius De Leon Asuncion, Singapore (SG)

(21) Appl. No.: 19/067,031

(22) Filed: Feb. 28, 2025

(51) Int. Cl. G06F 3/041; G06F 3/044

(52) U.S. Cl. CPC G06F 3/0418; G06F 3/04162; G06F 3/0442; G06F 3/0446

(57) ABSTRACT

According to an embodiment, a touch controller includes an oscillator generating a low-frequency reference signal, a phase-locked loop generating a high-frequency clock signal based on the reference signal, and a calibration circuit measuring timing differences between the high-frequency clock and a periodically enabled external reference clock from a processor. The calibration circuit performs multiple measurements during an initial enabled period and averages verified measurements to establish baseline timing parameters. New measurements are filtered with previous values during subsequent enabled periods using an infinite impulse response filter. A clock divider generates timing signals using a nominal ratio and periodically adjusts between the nominal and modified ratios based on the filtered measurements. The touch controller performs capacitive measurements on touch panel electrodes, transmits uplink signals through voltage modulation, and demodulates downlink signals during defined timeslots.

### TECHNICAL FIELD

The present disclosure generally relates to electronic devices and, in particular embodiments, to clock synchronization using periodic external reference calibration.

### BACKGROUND

Modern electronic devices incorporate touch panels that enable user interaction through capacitive sensing. These touch panels contain an array of transmitter (TX) and receiver (RX) electrodes arranged in a grid pattern. The transmitter and receiver electrodes form mutual capacitances at their intersections and self-capacitances to ground. Touch controllers measure changes in these capacitances to detect finger touches on the panel surface.

Touch panels can support multiple sensing modes. In mutual sensing mode, the touch controller applies signals to transmitter electrodes and measures the coupled charge at receiver electrodes to detect changes at the intersections. Self-sensing mode measures the capacitance of individual transmitter or receiver electrodes relative to ground. The touch controller can also monitor environmental noise by listening to the electrodes during dedicated noise-sensing periods.

Beyond basic touch detection, touch panels can enable active pen input through electrostatic communication. In one type of protocol, the touch controller initiates pen detection by periodically transmitting uplink signals on the TX/RX electrodes. These uplink signals can encode configuration information, such as preferred downlink frequencies. When a pen in proximity detects an uplink signal, it responds by transmitting downlink data packets during defined timeslots relative to the uplink. The downlink packets contain information, such as pressure levels measured by sensors in the pen tip. In another type of protocol, the pen initiates the communication by periodically sending a downlink signal, and the touch controller detects the downlink and synchronizes to it for listening to the pen.

Whether the touch controller or the pen initiates the process, reliable pen communication requires synchronized timing between the touch controller and the pen. Traditionally, both devices incorporate crystal oscillators to maintain precise clock synchronization. However, crystal oscillators add component cost. An alternative approach uses an external reference clock from the application processor to drive the touch controller timing. While this eliminates the dedicated crystal, keeping the application processor continuously active to provide the clock increases system power consumption.

### SUMMARY

Technical advantages are generally achieved by embodiments of this disclosure, which describe clock synchronization using periodic external reference calibration.

A first aspect relates to a system, comprising a touch panel comprising electrodes arranged in a grid pattern; a processor configured to generate a periodically enabled external reference clock; and a touch controller coupled to the touch panel and the processor, the touch controller comprising an oscillator configured to generate a low-frequency reference signal, a phase-locked loop coupled to the oscillator and configured to generate a high-frequency clock signal based on the low-frequency reference signal, a calibration circuit configured to measure timing differences between the high-frequency clock signal and the external reference clock during enabled periods; and compute error values based on the measured timing differences; a clock divider configured to generate timing signals for touch panel operation using a nominal ratio; and adjust the nominal ratio based on the computed error values, and an analog front-end configured to perform capacitive measurements on the electrodes; transmit uplink signals through voltage modulation; and demodulate downlink signals during defined timeslots; or directly synchronize to a downlink signal; and demodulate downlink signals during defined timeslots.

A second aspect relates to a method, comprising measuring timing differences between a high-frequency clock signal and a periodically enabled external reference clock during enabled periods; computing error values based on the measured timing differences; generating timing signals for touch panel operation using a nominal ratio; adjusting the nominal ratio based on the computed error values; performing capacitive measurements on touch panel electrodes; transmitting uplink signals through voltage modulation; and demodulating downlink signals during defined timeslots; or directly synchronizing to a downlink signal; and demodulating downlink signals during defined timeslot.

A third aspect relates to a circuit, comprising a first counter configured to count cycles of an external reference clock and assert signals at predetermined count thresholds; a second counter configured to count cycles of a high-frequency clock and provide cycle count values; a first logic gate coupled to receive a reset signal and the external reference clock; a second logic gate coupled to outputs of the first counter and the second counter and configured to generate a window closure signal; a latch coupled to the second counter and configured to capture cycle count values in response to the window closure signal; and provide captured values for computing timing differences; and a divider circuit configured to receive computed timing differences; and adjust division ratios based on the timing differences.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a simplified block diagram of an embodiment system for bidirectional communication;

FIG. 2 is a block diagram of an embodiment stylus-enabled device;

FIG. 3 is a block diagram of a touch controller;

FIG. 4 is a block diagram of an embodiment touch controller incorporating a clock circuit for generating precise timing signals with a periodically enabled reference clock;

FIG. 5 shows timing relationships for an example implementation of clock signals during a calibration window in accordance with the embodiments disclosed herein;

FIG. 6 shows timing relationships 600 for an embodiment LTJ mitigation implementation through an initial calibration period followed by periodic calibration windows;

FIG. 7 is a schematic of an embodiment calibration circuit implemented as an asynchronous logic circuit;

FIG. 8 shows timing relationships 800 for an example of calibration circuit implementation;

FIG. 9 is a block diagram of an embodiment calibration circuit implemented as a finite state machine (FSM);

FIG. 10 is a flowchart of an embodiment method for operating a calibration circuit based on the embodiments disclosed; and

FIG. 11 is a flowchart of embodiment method for operating a touch controller based on the disclosed embodiments.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of touch controllers with active pen detection capabilities, it should also be appreciated that these inventive aspects may also apply to any system requiring precise clock synchronization between devices where one device relies on a periodically enabled external reference clock. In particular, aspects of this disclosure may similarly apply to wireless communication systems, sensor interfaces, display controllers, audio processors, or other mixed-signal systems where multiple devices need to maintain synchronized timing while optimizing power consumption through periodic clock gating.

Aspects of the disclosure relate to systems and methods for maintaining precise timing synchronization using a periodically enabled external reference clock. A touch controller includes a low-frequency oscillator circuit generating a stable reference having a low long-term jitter noise in particular, that feeds into a phase-locked loop to produce a high-frequency clock signal. A clock divider circuit coupled to the phase-locked loop output generates lower frequency timing signals for touch and pen detection protocols. The touch controller receives an external reference clock from an application processor, where the external clock can be periodically enabled and disabled to reduce system power consumption.

During periods when the external reference clock is enabled, a calibration circuit opens measurement windows defined by counting cycles of the external clock. Within each measurement window, the calibration circuit counts cycles of the high-frequency clock and compares the count against an expected ideal value to determine systematic frequency errors. The calibration circuit implements averaging across multiple measurement windows during an initial extended enable period of the external reference clock to establish baseline timing parameters while minimizing the effects of random jitter in both clock sources.

During subsequent shorter enable periods of the external reference clock, the calibration circuit performs new measurement windows and updates the timing parameters using an infinite impulse response filter. The filtered updates allow the system to track gradual changes in the high-frequency clock characteristics while maintaining stability. The calibration circuit provides the filtered timing parameters to control how the clock divider periodically adjusts its division ratio to compensate for the measured frequency errors.

The clock divider generates the lower frequency timing signals by dividing the high-frequency clock by a nominal ratio L during normal operation. Based on the measured frequency error, the clock divider periodically uses modified ratios such as L+1 or L−1, where L is an integer greater than one, to realign the output timing with an ideal reference clock. The spacing between these periodic adjustments corresponds to the reciprocal of the measured frequency error to provide smooth correction. Additional division ratios beyond N+1 can be employed to enable precise fractional corrections when needed.

The touch controller includes logic to selectively apply timing parameter updates from the calibration circuit. The updates can be applied immediately when new measurements complete or synchronized to frame boundaries of the pen detection protocol to minimize timing discontinuities. Through continuous calibration and smooth clock division adjustments, the system maintains precise synchronization for reliable pen communication while allowing the external reference clock to be disabled during extended periods to reduce power consumption. These and additional details are further discussed below.

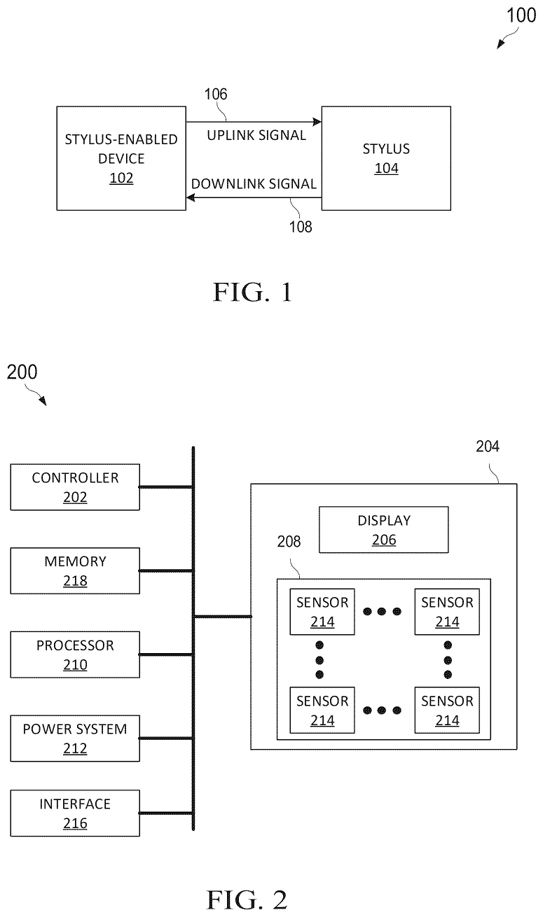

FIG. 1 illustrates a simplified block diagram of an embodiment system 100 for bidirectional communication. System 100 includes a stylus-enabled device 102 coupled to a stylus 104 through uplink signal 106 and downlink signal 108. The stylus-enabled device 102 includes a touch panel with an array of transmitter and receiver electrodes arranged in a grid pattern for detecting capacitive touch inputs and stylus signals.

The touch panel electrodes enable mutual capacitance sensing between transmitter and receiver electrodes and self-capacitance sensing of individual electrodes relative to ground. This electrode configuration allows the touch panel to detect finger touches while supporting electrostatic communication with the stylus 104. The stylus position is determined through self-sensing or mutual sensing measurements of the touch panel electrodes.

In the first type of protocol, the communication protocol operates in frames, with each frame beginning with an uplink signal 106 followed by designated timeslots for downlink signal 108 transmissions. The stylus-enabled device 102 initiates communication by transmitting the uplink signal 106 through voltage modulation on the touch panel electrodes. The uplink signal 106 carries timing information and configuration parameters, including frequency settings and timing requirements for subsequent downlink transmissions.

The stylus 104 includes transmitter circuits in the tip and ring regions that have hardware capability for detecting the uplink and generating the downlink signal 108 during defined timeslots relative to the received uplink signal 106. The transmitter circuits modulate voltage levels to encode information such as pressure sensor measurements. The downlink signal 108 couples electrostatically to the touch panel electrodes, where the stylus-enabled device 102 performs self-sensing or mutual sensing measurements to determine the stylus position while demodulating the signal to extract the encoded sensor information.

During normal operation, the stylus-enabled device 102 can adapt the uplink signal 106 parameters based on operating conditions. Once the stylus 104 location is known, the stylus-enabled device 102 may transmit the uplink signal 106 using a subset of electrodes near the last known stylus position rather than the entire electrode array. The stylus 104 monitors these uplink signals 106, which may contain updated timing or configuration parameters. In this type of protocol, the touch controller is the master of the frame start.

In a second type of protocol, the communication protocol operates in frames, with each frame beginning with a downlink signal 108 that may be followed by designated timeslots for signaling the frame start to the touch controller. The stylus-enabled device includes hardware capability for detecting the downlink signal 108 and synchronizing with it. In this type of protocol, the stylus is the master of the frame start.

Whether of the first or the second type, the communication protocol's reliability generally depends on maintaining precise timing synchronization between devices. Timing errors can prevent proper detection of downlink signal 108 during expected timeslots, as the stylus-enabled device 102 must align its self-sensing or mutual sensing measurements and demodulation windows with the stylus 104 transmissions. Traditional implementations achieve this synchronization using crystal oscillators in both devices. Although the description of the system is illustrated based on the first type of protocol, all considerations of timing synchronization are equally applicable to the second type of protocol and to any synchronization requirement between two devices.

To reduce costs, the stylus-enabled device 102 can operate from an external clock provided by an application processor instead of a dedicated crystal. While using an always-on external clock maintains synchronization, it prevents the application processor from entering low-power modes. System 100 supports operation with a periodically enabled external reference clock to improve power efficiency while maintaining the precise timing required for the communication protocol.

FIG. 2 illustrates a block diagram of an embodiment stylus-enabled device 200, which may be implemented as stylus-enabled device 102. Stylus-enabled device 200 includes a touch controller 202, a touchscreen 204, a memory 218, a processor 210, a power system 212, and an interface 216, which may (or may not) be arranged as shown. Stylus-enabled device 200 may include additional components not depicted, such as long-term storage (e.g., non-volatile memory, etc.), additional input and output interfaces, sensors, speakers, or the like.

In embodiments, touch controller 202 is arranged on a System-on-Chip (SoC). Touch controller 202 may be any component or collection of components adapted to perform computations or other signal processing-related tasks. In embodiments, during normal operation, touch controller 202 controls the operation of touchscreen 204. For example, in some embodiments, touch controller 202 acquires input data from the touchscreen 204 to determine the location and the type of touch. Additionally, touch controller 202 is configured to generate the uplink signal by modulating a voltage on the x-axis or y-axis sensors (i.e., electrodes) of the touch-sensing layer 208.

Processor 210 is configured to operate stylus-enabled device 200. In embodiments, processor 210 is implemented as a general-purpose, custom controller, host processor, or application processor coupled to memory 218 and configured to execute instructions from memory 218 or another memory of stylus-enabled device 200.

In embodiments, processor 210 may be coupled to a second memory of stylus-enabled device 200, which stores the instructions to be executed by processor 210. In some embodiments, touch controller 202 is implemented as part of processor 210. In embodiments, processor 210 is a primary processing unit, and touch controller 202 is an auxiliary processing unit. In embodiments, the touch controller 202 and the processor 210 may be implemented as a single processing unit.

Memory 218 may be any component or collection of components adapted to store programming or instructions for execution by touch controller 202, the processor 210, or both. In an embodiment, memory 218 includes a non-transitory computer-readable medium. In some embodiments, memory 218 is part of processor 210. In some embodiments, memory 218 is external to processor 210, such as inside touch controller 202. Other implementations are also possible. In some embodiments, memory 218 may also store other data types.

Interface 216 may be any component or collection of components that allow stylus-enabled device 200 to communicate with other devices/components or a user. For example, interface 216 may be adapted to receive wireless power from an external source using a transceiver circuit and antennas. Further, interface 216 may include circuitry that allows stylus-enabled device 200 to communicate signals externally or internally within the stylus-enabled device 200, a user, or a stylus.

In embodiments, touchscreen 204 allows users to interact and communicate with the stylus-enabled device 200 using touch or a stylus. It includes a display layer 206 and a touch-sensing layer 208.

The display layer 206 is configured to display images. In embodiments, a panel driver (not shown) may be coupled to the display layer 206 and the processor 210 and used to drive the display layer 206. The display layer 206 may comprise various technologies, such as a light-emitting diode (LED) display, an organic LED (OLED) display, a liquid crystal display (LCD), or an active-matrix organic LED (AMOLED) display.

The touch-sensing layer 208 can include an array of sensors arranged as a grid (e.g., a touch grid, touch cells, or sensing elements). For example, the touch-sensing layer 208 can include a plurality of sensors 214 arranged in rows and columns. Sensors 214 and the touch-sensing layer 208 may be implemented in any way known in the art. In embodiments, touchscreen 204 is capacitive. The sensors 214 in the touch-sensing layer 208 can detect the voltage modulations from the stylus 104, which couple to the sensor electrodes.

The touch-sensing layer 208 can register user input via touches made to the surface of the display layer 206. Touch-sensing layer 208 may also be configured to detect input from other inputs, such as a stylus (active or passive) device. In embodiments, the touchscreen 204 may include sensors such as gyroscopes or accelerometers. One or more of these sensors may be integrated.

In embodiments, touchscreen 204 may be configured to receive image data to be displayed on the display layer 206. In various embodiments, touch controller 202 and touch-sensing layer 208 may be configured to operate based on mutual capacitance sensing techniques, self-capacitive sensing techniques, stylus (or pen) sensing techniques, or a combination thereof.

Mutual capacitive sensing, or mutual sensing data, refers to a touchscreen technology where touch detection is based on measuring the capacitance between two sensors, usually arranged in a grid of rows and columns. In this system, one sensor (the transmitter) emits a signal, and the corresponding change in capacitance is detected by the other sensor (the receiver). When a finger or a stylus approaches or touches the display layer 206, it interferes with the electric field between the sensors of the touch-sensing layer 208, changing the mutual capacitance at that point, which is then detected by the system. For stylus detection, touch controller 202 can use the sensor electrodes to detect the voltage modulations from, for example, the dual transmitters of the stylus 104, which allow for precise position computation.

Mutual capacitive sensing's primary advantage is its ability to accurately detect and track multiple touch points, allowing advanced multi-touch functionalities. Due to its high resolution and precision in detecting touch inputs, which are used in modern touchscreens, it is suitable for applications requiring complex gestures and interactions.

Conversely, self-capacitive sensing, or self-sensing data, detects touch based on the change in capacitance of individual sensors in the touch-sensing layer 208. This method measures the capacitance between each sensor and the ground. When a finger or stylus is near or touching the display layer 206, it acts as a conductive object, altering the self-capacitance of the sensor in the touch-sensing layer 208, which the system recognizes as a touch.

Self-capacitance faces challenges in distinguishing between multiple simultaneous touches. At the same time, mutual capacitance is better suited for multi-touch detection, as each row and column intersection can be measured independently. However, self-capacitance excels in applications where simple touch interactions are sufficient and cost-effectiveness is a priority. Further, self-capacitance is generally more sensitive to conductive objects and can detect proximity from a greater distance, but it may be more susceptible to noise and interference. While less sensitive than self-capacitance, mutual capacitance is generally more precise and less prone to noise and interference.

The stylus scanning protocol between stylus-enabled device 102 and stylus 104 operates in frames, with each frame lasting approximately 8.3 ms in example embodiments. The communication protocol begins with the touch controller 202 periodically sending the uplink signal 106 by driving one or more transmitter or receiver electrodes in the touch panel to signal its presence to nearby stylus devices.

The uplink signal 106 can include configuration information, such as preferred frequencies that the stylus 104 should use for downlink communications. It can also include preamble, data, and cyclic redundancy check (CRC) information. In embodiments, the uplink signal 106 operates at frequencies around 100 kHz with voltage levels between 3V and 9V and may use encoding schemes such as Manchester encoding.

The operation begins on the stylus 104 side with an uplink detection period, during which the stylus 104 monitors for uplink signal 106 from the touch controller 202. When the stylus 104 is near the touch panel, it detects and decodes the uplink signal 106. Once the stylus 104 identifies the touch controller 202 through the uplink signal 106, the stylus 104 transmits downlink signal 108 during defined timeslots (e.g., Slot₀, Slot₁, Slot₂, . . . . Slot_{N}) within the frame.

The timeslots in the downlink signal 108 may contain each of them bits (e.g., B₀, B₁, B₂, . . . , B_{P}). In embodiments, these signals operate at frequencies between 85 kHz and 500 kHz with voltage levels from 20V to 60V, depending on the protocol implementation. The downlink signal 108 can be transmitted using various encoding schemes, including no encoding, binary phase-shift keying (BPSK), or quadrature phase-shift keying (QPSK), as the protocol specifies.

Following the transmission of uplink signal 106, the touch controller 202 opens In-phase and Quadrature (IQ) demodulation windows corresponding to the expected timeslots of downlink signal 108. The touch controller 202 processes the downlink signal 108 based on the expected timing of these timeslots.

During each timeslot, the touch controller 202 performs IQ demodulation to extract the encoded data while determining stylus position through self-sensing or mutual sensing measurements of the touch panel electrodes. To successfully decode the downlink signal 108, the touch controller 202 and stylus 104 use crystal oscillators to synchronize precise timing through a common reference clock throughout the communication frame.

Power system 212 provides a power source for the operation and portability of stylus-enabled device 200. Power system 212 may be a power management integrated circuit (PMIC). Power system 212 may include a controller, a battery, a charging circuit, an interface, and other components to allow inductive charging by transferring power from a charging pad or a base station to the stylus-enabled device 200. The power system 212 may be any component or collection of components that manage and control power distribution, conversion, and regulation in the stylus-enabled device 200. In various embodiments, power system 212 is configured to regulate supply voltage to various components of stylus-enabled device 200 and control the charging, discharging, and monitoring of the operations of a battery.

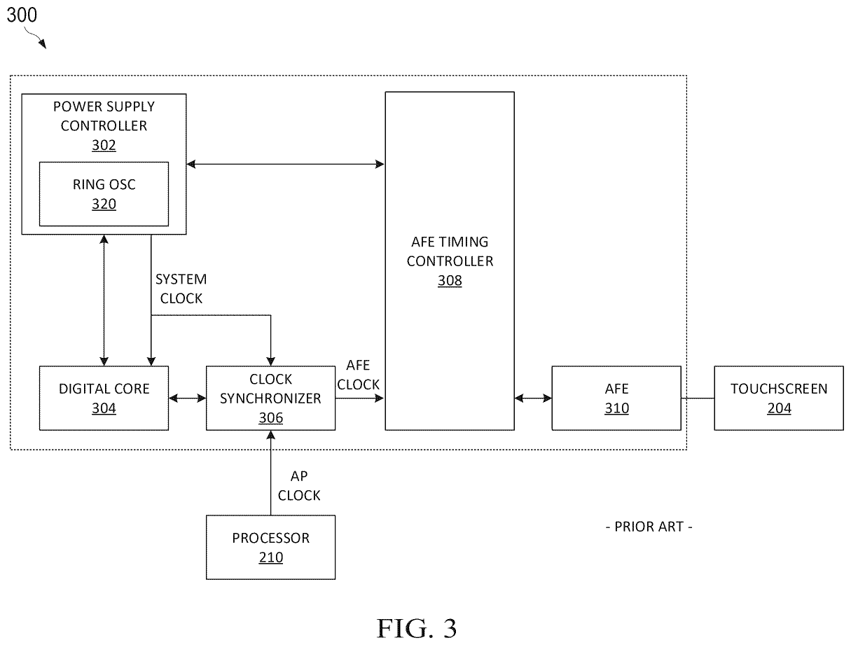

FIG. 3 illustrates a block diagram of a touch controller 300, which may be implemented as the touch controller 202 of FIG. 2. The touch controller 300 is coupled to the touchscreen 204 and the processor 210 and includes a power supply controller 302, a digital core 304, a clock synchronizer 306, an analog front-end (AFE) controller 308, and an analog front-end (AFE) 310, which may (or may not) be arranged as shown. Touch controller 300 may include additional components not shown.

The power supply controller 302 manages power distribution within touch controller 300 and includes ring oscillator 320, which generates a system clock, typically 192 MHz, for the digital core 304. The digital core 304 uses this higher frequency system clock to process touch and stylus data and control overall touch controller operations.

The AFE timing controller 308 requires a precise 32 MHz clock to generate timing signals that control the AFE 310. This lower-frequency AFE clock must maintain high accuracy to ensure proper synchronization with stylus devices during uplink and downlink communications. The clock synchronizer 306 manages the timing relationship between the higher frequency system clock domain and the precise 32 MHz AFE clock domain.

The AFE 310 interfaces directly with touchscreen 204 to drive the transmitter electrodes and receive signals from the receiver electrodes for touch sensing and stylus communication. While the system clock from ring oscillator 320 can have relaxed frequency accuracy for digital processing tasks, the AFE clock must maintain precise frequency control to ensure reliable stylus communication and accurate touch sensing.

In this conventional implementation, processor 210 must remain continuously powered to provide the 32 MHz AFE clock to touch controller 300. While this approach eliminates the need for a dedicated crystal oscillator in the touch controller 300, it prevents processor 210 from entering low-power modes, increasing system power consumption. This power impact becomes particularly significant in battery-powered devices, where processor 210 could otherwise enter sleep modes during periods of low activity.

An alternative approach (not shown) uses a dedicated crystal oscillator within touch controller 300 to generate the 32 MHz AFE clock. While this allows processor 210 to enter low-power modes, it increases system cost due to the addition of the crystal oscillator component. Crystal oscillators also occupy valuable circuit board area and add complexity to the touch controller design.

The frequencies of 192 MHz for the system clock and 32 MHz for the AFE clock represent example implementations. The system clock frequency can be selected based on factors such as digital processing throughput requirements and power consumption targets. Similarly, the AFE clock frequency can be chosen based on touch panel scanning rates, stylus communication protocols, and analog front-end timing requirements. Various implementations may employ different frequency values while maintaining the architectural concept of a higher-frequency system clock domain for digital processing and a precise lower-frequency clock domain for analog front-end control.

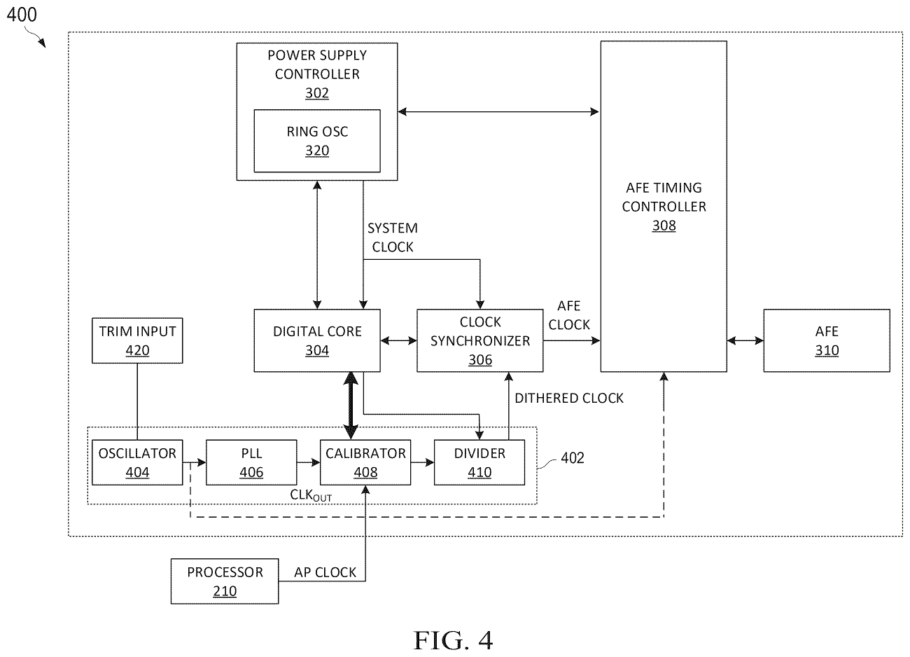

FIG. 4 illustrates a block diagram of an embodiment touch controller 400 incorporating clock circuit 402 for generating precise timing signals with a periodically enabled reference clock. Touch controller 400 includes similar components to touch controller 300 but adds clock circuit 402 between processor 210 and the AFE timing controller 308 and clock synchronizer 306. Clock circuit 402 is also coupled to digital core 304 and includes a trim input 420 for configuration. Components previously described with reference to FIG. 3 are not discussed in detail for brevity.

Clock circuit 402 includes a low Long-Term-Jitter (low-LTJ) RC oscillator 404, a phase-locked loop (PLL) 406, a calibration circuit 408, and a divider circuit 410, which may (or may not) be arranged as shown. Clock circuit 402 may include additional components not shown.

The low-LTJ RC oscillator 404 generates a stable low-frequency reference, for example 16 MHz. RC oscillators can be designed to operate at either low or high frequencies, but achieving good long-term jitter performance becomes increasingly challenging at higher frequencies. Accordingly, the clock circuit 402 can better maintain stable timing characteristics over extended periods by implementing the low-LTJ RC oscillator 404 to operate at a lower frequency.

The trim input 420 enables coarse frequency calibration of low-LTJ RC oscillator 404 during production. Through trim input 420, circuit parameters within low-LTJ RC oscillator 404 can be adjusted to calibrate its absolute output frequency closer to the target value. This initial coarse calibration reduces the magnitude of frequency error that must be compensated for during normal operation.

The low-LTJ RC oscillator 404 employs a low long-term jitter (LTJ) architecture focusing on frequency stability over extended periods rather than optimizing for cycle-to-cycle variations. While traditional ring oscillators may prioritize minimizing period-to-period jitter, the LTJ design of the low-LTJ RC oscillator 404 includes additional circuitry to maintain consistent frequency despite variations in temperature, supply voltage, and other environmental factors that could cause timing drift over longer periods.

In embodiments, instead of absolute value trimming at one temperature, two-point temperature trimming may be implemented by trimming the temperature coefficient to ensure stability over a large range of temperatures. This long-term stability is advantageous for maintaining synchronization across multiple stylus communication frames.

Further, operating the low-LTJ RC oscillator 404 at a lower frequency helps minimize jitter effects. The longer oscillation period allows the circuit to settle between transitions, reducing sensitivity to noise and variation sources. This results in more stable edges for timing references and reduces the rate of timing error accumulation that could otherwise disrupt stylus synchronization.

The PLL 406 receives the low-frequency reference signal from the low-LTJ RC oscillator 404 and performs frequency multiplication to generate a high-frequency output clock (CLK_{OUT}). The PLL feedback divider configuration determines the multiplication factor between input and output frequencies. For example, when receiving a 16 MHz input from the low-LTJ RC oscillator 404, PLL 406 applies a multiplication factor of twelve to generate a 192 MHz output clock.

While frequency multiplication in PLLs typically amplifies input jitter by the same factor as the frequency multiplication, PLL 406 can incorporate filtering in its feedback loop to help suppress this effect. The PLL's loop bandwidth and filter characteristics can be configured to provide jitter filtering while maintaining lock stability. This allows the high-frequency output to preserve the long-term stability benefits achieved by generating the initial reference at a lower frequency through the low-LTJ RC oscillator 404.

In embodiments, calibration circuit 408 is implemented as a finite state machine. It is configured to measure timing differences between the high-frequency clock from PLL 406 and the external reference clock from processor 210. The calibration circuit 408 opens measurement windows defined by counting cycles of the external reference clock. Within each measurement window, it counts cycles of the high-frequency clock and compares the count against an expected ideal value to determine systematic frequency errors.

Calibration circuit 408 is coupled to the digital core 304 and receives set and reset signals to control its state transitions. The calibration circuit 408 provides several status signals back to digital core 304, including a calibration window signal indicating the completion of a calibration window, a measured clock cycle count value representing the measured high-frequency clock cycle count, a valid measurement signal indicating that a valid measurement has been completed, and an error checking signal that provides error checking information. These signals enable the digital core 304 to monitor the calibration process and compute the required divider adjustments.

In embodiments, when processor 210 first enables its reference clock, calibration circuit 408 performs multiple measurement windows to establish baseline timing parameters. This initial calibration period allows the system to average out random variations and establish stable timing relationships. For power efficiency, processor 210 can disable its reference clock output and enter low-power modes. When processor 210 periodically re-enables its reference clock, calibration circuit 408 performs new measurements to track any timing drift that may have occurred during the off period. The reference clock's periodic on/off operation enables power savings while maintaining accurate timing through regular recalibration.

In embodiments, the calibration measurements begin when calibration circuit 408 detects an active reference clock from processor 210. The circuit opens a measurement window by starting to count cycles of the reference clock and the high-frequency clock. When the reference clock count reaches a predetermined value, the circuit captures the high-frequency clock count and signals completion to digital core 304. The digital core 304 uses these measurements to compute the error value (N_{ERROR}):

$${N}_{ERROR} = \frac{{N}_{T}}{δ N} ,$$

where N_{T} represents an ideal clock cycle count and δN represents the measured deviation. The error value is used to fine-tune the AFE clock signal from the divider circuit 410 by setting how frequently the divider circuit 410 adjusts its division ratio to maintain precise timing alignment.

The calibration circuit 408 measures frequency differences between the high-frequency and external reference clocks during enabled periods. In embodiments, the external reference clock from processor 210 can operate at various frequencies, including 8 MHz, 16 MHz, 19.2 MHz, 32 MHz, 38.4 MHz, or 64 MHz. These measurements determine how divider circuit 410 should adjust its division ratio to maintain synchronization.

Divider circuit 410 generates the analog front-end (AFE) clock by dividing the high-frequency clock from PLL 406. During normal operation, it uses a nominal division ratio L to generate the desired output frequency. For example, to generate a 32 MHz output from a 192 MHz input, L=6 is used as the nominal division ratio.

Divider circuit 410 periodically adjusts its division ratio based on the calibration measurements to maintain precise frequency alignment with the external reference clock. For example, it can temporarily use ratios of L−1 or L+1 to correct accumulated timing errors. In the example where L=6, ratios of 5 or 7 can occasionally be used. This dithering between division ratios enables fine adjustment of the average output frequency.

While specific division ratios of L=6, L−1=5, and L+1=7 are used as examples, these values are non-limiting. The division ratios can be selected based on the relationship between the PLL output frequency and the desired analog front-end clock frequency. Additional division ratios beyond N±1 may also enable more precise frequency adjustment.

In embodiments, the calibration process repeats when the external reference clock is enabled. This allows clock circuit 402 to track and compensate for frequency variations while enabling processor 210 to enter low-power modes when the reference clock is disabled.

In embodiments, touch controller 400 maintains backward compatibility with legacy applications where processor 210 provides an always-on external reference clock. The clock circuit 402 architecture supports both operating modes-either calibrating against a periodically enabled reference clock to enable processor power savings or operating with an always-on reference clock for legacy support. Legacy mode is not represented in FIG. 4 and can be achieved by, for example, overwriting the calibration circuit 408 to instruct the divider circuit 410 to use L=6 in the example.

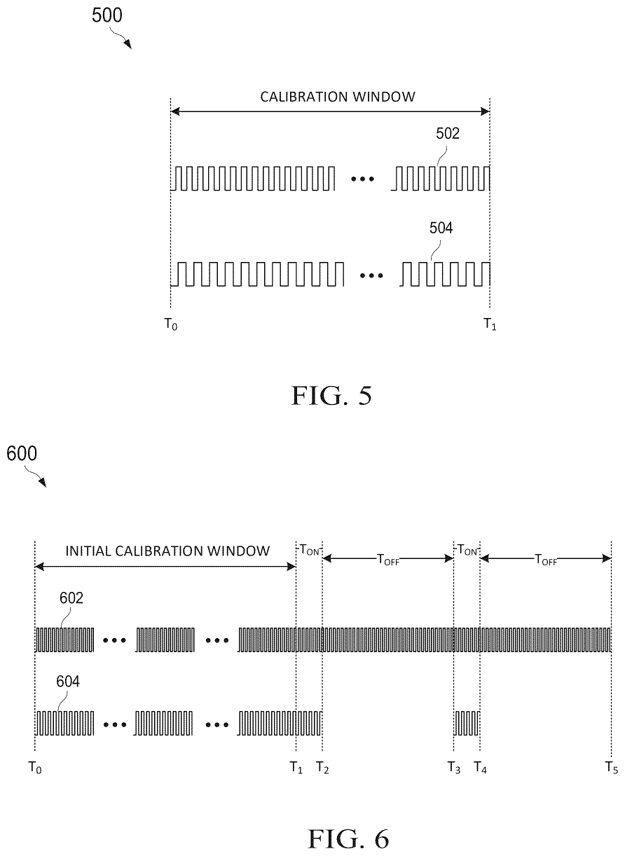

FIG. 5 illustrates timing relationships 500 for an example implementation of clock signals during a calibration window in accordance with the embodiments disclosed herein. A high-frequency output clock signal 502 from PLL 406 and an external reference clock signal 504 from processor 210 are shown from time T₀ to time T₁. The calibration window corresponds to a period when processor 210 is enabled and generates external reference clock signal 504, while PLL 406 continuously generates high-frequency output clock signal 502.

The calibration window duration is defined by counting cycles of the external reference clock signal 504 until reaching a predetermined count (N₁). For example, with external reference clock signal 504 operating at 8 MHz and a desired 5 ms window, the predetermined count (P) equals 40,000 cycles. During this same window, a high-frequency output clock signal 502 operating at 192 MHz should complete a target count (N_{T}) equal to 960,000 cycles (192 MHz×5 ms).

The target count (N_{T}) for high-frequency output clock signal 502 can be expressed as

$${N}_{T} = {W}_{0} \times {CLK}_{O U T} = P \times \frac{{CLK}_{OUT}}{{CLK}_{EXT}} ,$$

where W₀ is the calibration window duration in seconds, CLK_{OUT} is the frequency of high-frequency output clock signal 502, and CLK_{EXT} is the frequency of external reference clock signal 504. In embodiments, the external reference clock signal 504 frequency can be 8 MHz, 16 MHz, 19.2 MHz, 32 MHz, 38.4 MHz, or 64 MHz while remaining lower than the high-frequency output clock signal 502.

During calibration, systematic frequency errors in high-frequency output clock signal 502 are measured. For example, with high-frequency output clock signal 502 operating at 192 MHz±0.5%, the actual cycle count during the calibration window may vary from the target count (N_{T}) by ±4,800 cycles (derived from δN=N_{T}×±0.5%=±4,800 for a 192 MHz±0.5% high-frequency output clock). This variation corresponds to a systematic error value of +200

$$( derived from {N}_{ERROR} = \frac{{N}_{T}}{δ N} = \frac{960 , 000}{\pm 4 , 800} = \pm 2 \; 00 ) .$$

The calibration window repeats periodically when processor 210 enables its reference clock, for example, 5 ms every 100 ms. Divider circuit 410 uses the measured, systematic error between calibration windows to determine the spacing of its division ratio adjustments.

For example, with a systematic error of 200, divider circuit 410 makes its first correction after 200 cycles using L−1 or L+1 instead of the nominal ratio L. The second correction occurs after 400 cycles, the third after 600 cycles, and so forth, continuing this pattern until the next calibration window begins. This periodic adjustment pattern maintains average frequency alignment throughout the interval between calibration windows.

The external reference clock signal 504 from processor 210 is an absolute time reference, effectively providing the functionality of a real-time clock (RTC). Since it is derived from a crystal oscillator in processor 210, it provides a highly accurate frequency reference against which the high-frequency output clock signal 502 can be calibrated.

The system uses the external reference clock signal 504 during each calibration window to measure absolute time intervals. The system establishes a precise calibration time window by counting a fixed number (P) of cycles for the external reference clock signal 504. This window is a reference duration against which the number of cycles of the high-frequency output clock signal 502 can be counted and compared to their expected target count (N_{T}).

For example, when the external reference clock signal 504 operates at 8 MHz, counting 40,000 cycles establishes a precise 5 ms calibration window. Any deviation in the number of high-frequency output clock signal 502 cycles from the expected 960,000 during this window indicates a frequency error relative to this absolute time reference. The ratio between the measured and expected cycle counts provides the information needed to adjust the divider circuit 410 to maintain synchronization with this absolute time base.

This approach allows the system to periodically realign its timing with the absolute reference whenever processor 210 enables external reference clock signal 504. During periods when processor 210 disables its reference clock output, the system operates independently using the calibrated divider settings. The periodic realignment prevents long-term timing drift that could otherwise accumulate between the touch controller and stylus clocks.

The timing adjustments can be analyzed in terms of their impact on signal alignment. For example, with a systematic error value of 200, each correction interval of 200 cycles represents 1.041 microseconds at the high-frequency output clock signal 502 frequency of 192 MHz. In other words, the correction ensures the alignment happens every 1.041 microseconds. Due to the ±0.5% inaccuracy of the high-frequency output clock signal 502, the time shift accumulated over these 200 cycles equals 5.21 ns, calculated as ±0.5% of 1.041 microseconds. Hence, the correction by ± one clock cycle of the high-frequency output clock signal 502 ensures the alignment.

The impact of this timing shift can be evaluated relative to the downlink signal frequency. For a 400 kHz downlink signal with a 2.5 us period, the 5.18 ns accumulated time shift before the next correction corresponds to a phase shift of 0.74 degrees:

$$0.74 ° = \frac{518 ns}{2.5 μs} \times 360 ° .$$

When the systematic error of high-frequency output clock signal 502 is less than ±0.5%, the time between AFE clock corrections increases proportionally. While the correction principle remains the same, the larger interval between corrections indicates that as the frequency of the high-frequency output clock signal 502 is close to the target, very seldom is the alignment required. It is to be noted that despite the interval being large, the amount of correction required when alignment happens is always one high-frequency output clock signal 502 by the construction of the principle of operation of the system.

These timing calculations consider only the systematic frequency error of high-frequency output clock signal 502. Additional factors affecting timing accuracy include the precision of external reference clock signal 504, long-term jitter characteristics of the high-frequency output clock signal 502, and frequency variations due to temperature changes. These factors may require additional compensation mechanisms beyond the basic systematic error correction.

FIG. 6 illustrates timing relationships 600 for an embodiment LTJ mitigation implementation through an initial calibration period followed by periodic calibration windows. The timing diagrams include a high-frequency output clock signal 602 from PLL 406 and an external reference clock signal 604 from processor 210.

From time T₀ to T₁, an initial calibration window allows multiple measurements to establish baseline timing parameters. During this period, calibration circuit 408 performs multiple measurements and averages the results to minimize the impact of random variations in both clock signals.

After the initial calibration completes at time T₁, the system transitions to periodic operation where processor 210 alternates between enabling external reference clock signal 604 for the processor ON time durations (e.g., from time T₁ to T₂ and from time T₃ to T₄) and disabling it the processor OFF time durations (e.g., from time T₂ to T₀ and from time T₄ to T₅). These periodic ON-time windows allow calibration circuit 408 to track and compensate for any timing drift while enabling processor 210 to enter low-power modes during the OFF-time windows.

In embodiments, the system implements a calibration sequence to minimize the impact of long-term jitter (LTJ) in the high-frequency output clock signal 602 and external reference clock signal 604. This sequence begins with an initial calibration window from time Tₒ to time T₁ that precedes the first ON/OFF cycle starting at time T₁. During this initial calibration window, calibration circuit 408 performs multiple measurements, averaged together to establish a stable baseline that accounts for random variations in both clock signals. This averaging process helps filter out the effects of long-term jitter that may be present in either the high-frequency output clock signal 602 or external reference clock signal 604. Based on this arrangement, the system begins its periodic calibration sequence with reliable initial timing parameters before transitioning to the ON/OFF cycles at time T₁.

The initial calibration window is divided into M number of calibration and check windows. During each M calibration window, the actual cycle count (N_{M}) is subtracted from the target count (N_{T}), producing a respective deviation value (δN_{K}) for each M number of calibration windows: δN_{K}=N_{K}−N_{T}, where K is an integer from 1 to M. The M deviation values (δN_{AVG}) are averaged to produce an average deviation value (δN_{AVG}), where

$$δ {N}_{AVG} = {\sum }_{K = 1}^{M} δ {N}_{K} .$$

This averaging of multiple measurements during the initial calibration window helps establish a reliable baseline value before entering periodic ON/OFF operation. By processing multiple samples during an extended calibration window, random variations from long-term jitter in both clock signals can be averaged out to produce a more accurate initial calibration.

Following each calibration window within the initial calibration window, a check window can be employed to verify whether the external reference clock signal 604 remained active slightly longer than the calibration window duration. For example, the verification can include verifying whether the total cycles for the external reference clock signal 604 within each calibration window of the M calibration windows within the initial calibration window is equal to the predetermined count P+1%. The extra 1% is not used for counting but just used as a checkpoint guaranteeing the integrity of the external clock when the counting ended (count P), which indicates that the clock remains stable for another +1% after having counted P. This check ensures the measurement is valid by confirming processor 210 maintained the external reference clock signal 604 for the complete calibration window plus a margin. This can act as a safety measure for addressing the marginal case when the external clock would have progressively vanished around P count and, therefore, be corrupted around P count. If the check window verification fails, that measurement can be discarded rather than potentially corrupted data being included in the averaging calculation.

In embodiments, each of the M calibration windows within the initial calibration window terminates when either the external reference clock signal 604 reaches a predetermined count (P) or the cycle count of the high-frequency output clock signal 602 exceeds the target count (N_{T}) plus 2%. This termination criterion ensures valid measurements by either completing a full calibration window—count (P) of external clock reached—or detecting that the external clock did stop—count (N_{T}) of the high-frequency output clock signal 502 plus 2% exceeded without count of external clock being (P) reached. If a calibration window terminates due to the second condition, that measurement can be discarded rather than included in the averaging calculation. It should be appreciated that the 1% and 2% criteria are not hard limits, and for ease of digital implementation, for example, 0.78125% and 3.125% were used.

Table 1 illustrates values for the predetermined count (P), the target count (N_{T}), the predetermined count P+0.78125%, and the target count (N_{T}) plus 3.125% at example frequencies (F) of the external reference clock signal 604 for an ON duration of 1 ms for processor 210.

TABLE 1
ON Duration of 1 ms for Processor 210

| F | | P | N_{T} | P + 0.78125% | N_{T} + 3.125% |
|---|---|---|---|---|---|
| 8 | MHz | 8,000 | 192,000 | 62 | 6,000 |
| 16 | MHz | 16,000 | 192,000 | 125 | 6,000 |
| 19.2 | MHz | 19,200 | 192,000 | 150 | 6,000 |
| 32 | MHz | 32,000 | 192,000 | 250 | 6,000 |
| 38.4 | MHz | 38,400 | 192,000 | 300 | 6,000 |
| 64 | MHz | 64,000 | 192,000 | 500 | 6,000 |

Table 2 illustrates values for the predetermined count (P), the target count (N_{T}), the predetermined count P+0.78125%, and the target count (N_{T}) plus 3.125% at example frequencies (F) of the external reference clock signal 604 for an ON duration of 10 ms for processor 210.

TABLE 2
ON Duration of 10 ms for Processor 210

| F | | P | N_{T} | P + 0.78125% | N_{T} + 3.125% |
|---|---|---|---|---|---|
| 8 | MHz | 80,000 | 1,920,000 | 625 | 60,000 |
| 16 | MHz | 160,000 | 1,920,000 | 1,250 | 60,000 |
| 19.2 | MHz | 192,000 | 1,920,000 | 1,500 | 60,000 |
| 32 | MHz | 320,000 | 1,920,000 | 2,500 | 60,000 |
| 38.4 | MHz | 384,000 | 1,920,000 | 3,000 | 60,000 |
| 64 | MHz | 640,000 | 1,920,000 | 5,000 | 60,000 |

Table 3 illustrates values for the predetermined count (P), the target count (N_{T}), the predetermined count P+0.782125%, and the target count (N_{T}) plus 3.125% at example frequencies (F) of the external reference clock signal 604 for an ON duration of 50 ms for processor 210.

TABLE 3
ON Duration of 50 ms for Processor 210

| F | | P | N_{T} | P + 0.78125% | N_{T} + 3.125% |
|---|---|---|---|---|---|
| 8 | MHz | 400,000 | 9,600,000 | 3,125 | 300,000 |
| 16 | MHz | 800,000 | 9,600,000 | 6,250 | 300,000 |
| 19.2 | MHz | 960,000 | 9,600,000 | 7,500 | 300,000 |
| 32 | MHz | 1,600,000 | 9,600,000 | 12,500 | 300,000 |
| 38.4 | MHz | 1,920,000 | 9,600,000 | 15,000 | 300,000 |
| 64 | MHz | 3,200,000 | 9,600,000 | 25,000 | 300,000 |

Table 4 illustrates values for the predetermined count (P), the target count (N_{T}), the predetermined count P+0.78125%, and the target count (N_{T}) plus 3.125% at example frequencies (F) of the external reference clock signal 604 for an ON duration of 100 ms for processor 210.

TABLE 4
ON Duration of 100 ms for Processor 210

| F | | P | N_{T} | P + 0.78125% | N_{T} + 3.125% |
|---|---|---|---|---|---|
| 8 | MHz | 800,000 | 19,200,000 | 6,250 | 600,000 |
| 16 | MHz | 1,600,000 | 19,200,000 | 12,500 | 600,000 |
| 19.2 | MHz | 1,920,000 | 19,200,000 | 15,000 | 600,000 |
| 32 | MHz | 3,200,000 | 19,200,000 | 25,000 | 600,000 |
| 38.4 | MHz | 3,840,000 | 19,200,000 | 30,000 | 600,000 |
| 64 | MHz | 6,400,000 | 19,200,000 | 50,000 | 600,000 |

In each table, for simplicity, P+1% is implemented as a bit shift of 7

$$( i . e , \frac{P}{{2}^{7}} ) ,$$

resulting in a margin of 0.78125%, instead of 1%. Likewise, N_{T}+2% is implemented as a bit shift of 5

$$( i . e , \frac{{N}_{T}}{{2}^{5}} ) ,$$

resulting in a margin of 3.125% instead of 2%.

In an exemplary embodiment, the initial calibration window equals to 50.390625 ms, each calibration window equals 5 ms, each check window is equal to 0.78125% of 5 ms which is 39.0625 us, and M is equal to 10. Assuming that the frequency of the external reference clock signal 504 is set to 8 MHz, the predetermined count (P) equals 40,000, as P=CLK_{EXT}×W₀ (i.e., 40,000=8 MHz×5 ms). The high-frequency output clock signal 502 operating at 192 MHz results in a target count (N_{T}) equal 960,000, as N_{T}=CLK_{OUT}×W₀ (i.e., 960,000=192 MHz×5 ms).

In embodiments, during the ON/OFF cycles, an Infinite Impulse Response (IIR) filter is used to process frame-to-frame calibration measurements. This filtering approach helps minimize the impact of long-term jitter from the high-frequency output clock signal 602 and external reference clock signal 604. The IIR filter can be particularly effective at mitigating the impact of long-term jitter in external reference clock signal 604 by providing a weighted average of current and previous measurements.

For the first periodic calibration window, the average deviation value (δN_{AVG}) calculated during the initial calibration window is the first deviation value (δN). When the first ON period begins at time T₁, the new measurement produces a deviation value (δN₁) combined with the first deviation value (δN) using the IIR filter equation: δN_{NEXT}=S×δN_{PREVIOUS}+(1−S)×δN₁, where δN_{NEXT} refers to the next value to be applied for updating the alignment parameters and δN_{PREVIOUS} refers to the previous alignment parameter.

The coefficient S determines how quickly the system adapts to new measurements. For example, with S=0.9, the new deviation value (δN₁) measurement contributes 10%, while the first deviation value (δN) contributes 90% to the updated error value. By heavily weighting the well-averaged initial value while still allowing some adjustment based on new measurements, the system maintains stability while adapting to any timing drift that may occur after the initial calibration period.

This approach ensures a smooth transition from the initial calibration period to periodic operation. The value of S can be adjusted based on application requirements. A lower S value enables a faster response to frequency changes, while a higher S value provides more stable operation. The selection of S represents a compromise between responsiveness and stability. It can be tuned based on the expected rate of environmental changes, such as temperature variations that can cause oscillator frequency shifts.

After each calibration window during the periodic operation, the deviation value (δN) obtained through IIR filtering is used to compute a new system error value (N_{ERROR}) per the equation:

$${N}_{ERROR} = \frac{{N}_{T}}{δ N} .$$

For example, if the target count (N_{T}) equals 960,000 and the deviation value (δN) equals 4,800, the system error equals 200, meaning the divider circuit 410 should adjust its division ratio every 200 cycles.

The divider circuit 410 uses this computed error value to determine when to temporarily switch from its nominal division ratio L to either L−1 or L+1, where L is an integer greater than one, maintaining precise frequency alignment between calibration windows. This adjustment process continues using updated error values from each new calibration window, with the IIR filtering ensuring smooth transitions in the divider behavior as operating conditions change.

In embodiments, during periodic operation after the initial calibration window (after time T₁), the system can implement timing updates in two ways while maintaining stylus communication. In the first approach, new calibration measurements are used to update divider circuit 410 immediately, allowing on-the-fly adjustments to timing even within an active stylus communication frame. In a second approach, the system buffers the new calibration measurements and applies timing adjustments only at stylus frame boundaries.

Stylus communication operates in frames, each including uplink transmission followed by downlink timeslots for the first protocol type and only the downlink transmission for the second protocol type. When using on-the-fly updates, divider circuit 410 can adjust its division ratio as soon as calibration circuit 408 completes a new measurement during an ON period. While this provides immediate correction of timing errors, coordination with ongoing stylus communication can become necessary to maintain synchronization.

Alternatively, synchronizing timing updates to stylus frame boundaries provides more deterministic behavior. This approach stores new calibration measurements until the current stylus frame is completed. The divider circuit 410 then updates its division ratio at the start of the next frame, ensuring timing adjustments don't occur during active stylus communication sequences.

The described approaches of immediate on-the-fly updates and stylus frame-synchronized updates represent example implementations of how the system error values (N_{ERROR}) can be applied to divider circuit 410. These methods are non-limiting, and the calibration circuit 408 architecture supports implementing alternative update strategies. The finite state machine structure can accommodate various other approaches for coordinating timing updates with calibration measurements and stylus communication protocols, allowing the system to adapt to different operating requirements or timing constraints.

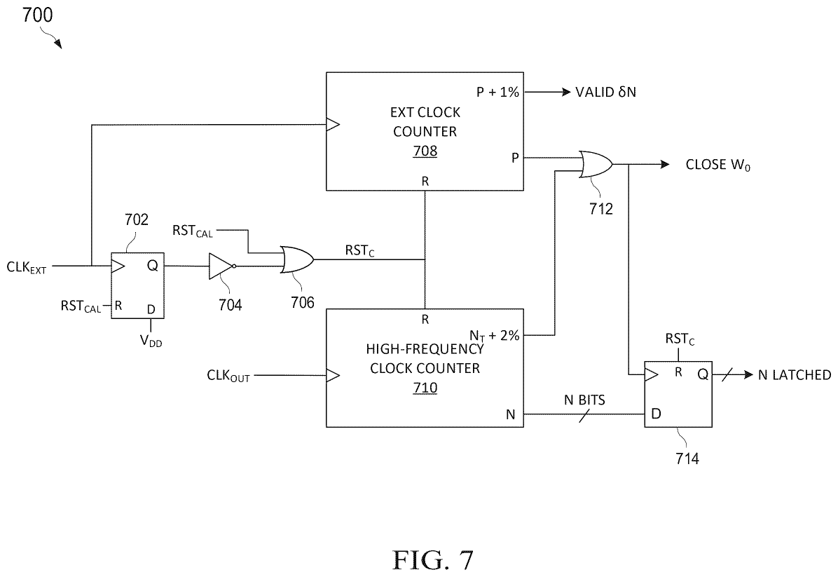

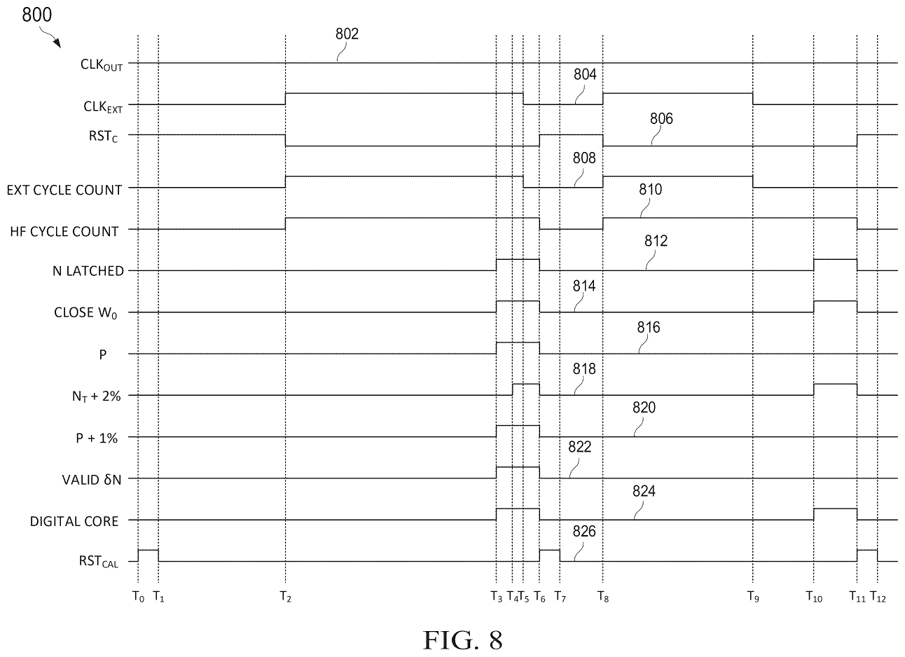

FIG. 7 illustrates a schematic of an embodiment calibration circuit 700 implemented as an asynchronous logic circuit, which can be implemented as calibration circuit 408 of FIG. 4. FIG. 8 illustrates timing relationships 800 for an example of calibration circuit 700 implementation.

Calibration circuit 700 determines timing relationships between the external reference clock signal (CLK_{EXT}) 804 from processor 210 and the high-frequency output clock signal (CLK_{OUT}) 802 generated by the PLL 406. The calibration circuit 700 generates control signals that manage calibration window timing and capture cycle count measurements.

Calibration circuit 700 includes a flip-flop 702, an inverter 704, a first OR gate 706, a first counter 708, a second counter 710, a second OR gate 712, and a latch 714, which may (or may not) be arranged as shown. The circuit interfaces with digital core 304 through the reset signal (RST_{CAL}) 826 and set signal, receives the external reference clock signal (CLK_{EXT}) 804 from processor 210, and receives the high-frequency output clock signal (CLK_{OUT}) 802 from PLL 406. The circuit outputs include the calibration window close signal (Close Wₒ) 814 from second OR gate 712, latched count value (N LATCHED) 812 from latch 714, a valid deviation signal (VALID δN) 822 from first counter 708, and the target count (N_{T}) plus 2% of the second signal 818 from second counter 710.

The initialization and reset path begin at time Tₒ with flip-flop 702, which receives the reset signal (RST_{CAL}) 826 at its reset input and the external reference clock signal (CLK_{EXT}) 804 at its clock input. The flip-flop output (Q) passes through inverter 704 to first OR gate 706, which is OR'ed with the reset signal (RST_{CAL}) 826 to generate the reset signal (RST_{C}) 806. The reset signal (RST_{C}) 806 provides synchronized reset control signals to first counter 708, second counter 710, and latch 714, ensuring proper initialization of the counting and latching operations while flip-flop 702 waiting for the external reference clock signal (CLK_{EXT}) 804 to arrive.

At times T₂ and T₈, counters 708 and 710 start counting as the reset signal (RST_{C}) 806 is de-asserted when the external reference clock signal (CLK_{EXT}) 804 arrives. Between times T₂ to T₅ and times T₈ to T₉, the first counter 708 counts the number of clock cycles of the external reference clock signal (CLK_{EXT}) 804 to track the external reference timing. At time T₃, it asserts the valid deviation signal (VALID δN) 822, indicating a valid deviation measurement is available.

Between times T₂ to T₆ and times T₈ to T₁₁, the second counter 710 simultaneously counts the number of clock cycles of the high-frequency output clock signal (CLK_{OUT}) 802, providing the cycle count 810 to latch 714 and generating a second signal 818 when the count exceeds the target count (N_{T}) plus 2%. This dual-counter arrangement enables comparison between the two clock domains.

Second OR gate 712 implements the calibration window closure logic by combining the P-reached signal 816 from first counter 708 and the second signal 818 indicating when the count exceeds the target count (N_{T}) plus 2% from second counter 710. The resulting calibration window close signal (Close Wₒ) 814 at times T₃ and T₁₀ triggers window closure under either condition, providing flexibility in handling normal operation and error cases. The window remains closed until the next reset signal (RST_{CAL}) 826. When the calibration window close signal (Close Wₒ) 814 asserts, latch 714 captures the current cycle count value (N) 810 of the high-frequency output clock signal (CLK_{OUT}), preserving the measurement for processing by digital core 304.

In embodiments, during a normal operation (first case), the predetermined count (P) 816 has been reached, causing the calibration window close signal (Close Wₒ) 814 to assert followed by the valid deviation signal (VALID δN) 822 assertion after the predetermined count P+1% number of cycles.

In embodiments, during an error scenario (second case), while the predetermined count (P) has not been reached and the calibration window close signal (Close Wₒ) 814 is asserted, the valid deviation signal (VALID δN) 822 fails to assert after the predetermined count P+1% number of cycles but the second signal 818 corresponding to the count exceeding the target count (N_{T}) plus 2% is asserted. This indicates premature termination of the external reference clock signal (CLK_{EXT}) 804. In this case, the system asserts the reset signal (RST_{CAL}) 826 directly, bypassing validation that the predetermined count (P) has been reached to handle the error condition gracefully.

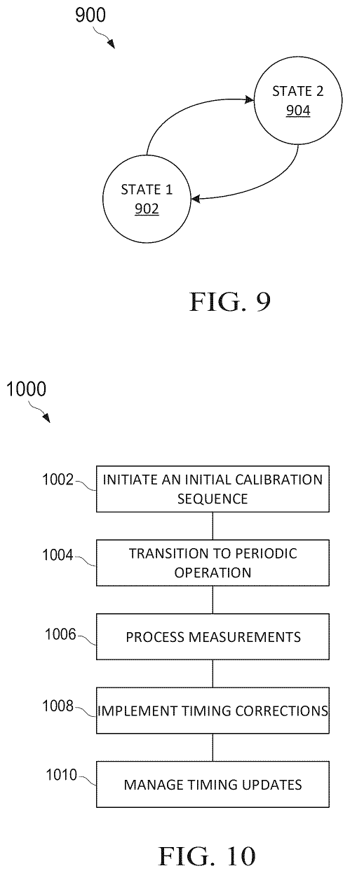

FIG. 9 illustrates a block diagram of an embodiment calibration circuit 900 implemented as a finite state machine (FSM), which can be implemented as the calibration circuit 408 of FIG. 4. Calibration circuit 900 transitions seamlessly between long-ON in a first state (STATE 1) 902 and ON/OFF sequences in a second state (STATE 2) 904.

For both operating modes, processor 210 maintains the external reference clock signal 604 for a duration exceeding the calibration window (Wₒ) by, for example, at least 2% (T_{ON}>Wₒ+2%) to enable the completion of a first calibration cycle. In embodiments, the margin of 2% ensures that the 1% criteria can always pass in normal scenario of presence of external clock. The FSM monitors two checkpoints: a first checkpoint verifying that the external reference clock cycle count exceeds the predetermined count P to complete the calibration cycle and a second checkpoint confirming the external reference clock count exceeds the predetermined count P+1%. Once the second checkpoint is reached and the deviation value (δN_{K}) is validated, the FSM can initiate a new cycle.

In the second state (STATE 2) 904, external reference clock signal 604 remains present for the minimum required margin after the calibration cycle is completed (e.g., remaining 1% after Wₒ+2%). When the FSM initiates a new cycle, if the first checkpoint is not verified (i.e., external reference clock cycle count does not reach the predetermined count P, indicating that the processor 210 has stopped operation), the high-frequency clock cycle count continues increasing until it exceeds the target count (N_{T}) plus 2%. At this point, the FSM closes the calibration window (Wₒ) and returns to reset mode because while the high-frequency clock count exceeds its threshold, the external reference clock cycle count fails to reach its checkpoint. This aborted cycle indicates ON/OFF mode operation and the FSM reinitiates for a new first cycle.

In the first state (STATE 1) 902, external reference clock signal 604 persists for more than twice the extended calibration window (e.g., >2×(W₀+2%)), enabling multiple complete cycles. The FSM restarts its cycle and reaches the first checkpoint successfully while the external reference clock signal 604 remains active. When the calibration window (Wₒ) closes, the high-frequency clock cycle count has not exceeded the target count (N_{T}) plus 2%, allowing the FSM to validate the deviation value (δN_{K}) and proceed with a second cycle. This scenario continues repeating cycles until external reference clock signal 604 stops. At this point, the FSM transitions to the first scenario behavior. This dual-scenario operation enables the FSM to maintain continuous calibration measurements while adapting to varying the external reference clock signal 604 availability patterns.

The FSM executes calibration operations seamlessly across the extended calibration window and ON/OFF sequences. While the sequence type affects how the deviation value (δN) is updated, the deviation value (δN) remains continuously available for timing adjustments throughout the operation. After the extended calibration window sequence, the deviation value (δN) computation employs a Finite Impulse Response (FIR) filter, averaging over M samples. At the same time, the processor 210 remains in always-ON mode.

The system can transition to the ON/OFF sequence under two conditions: when external reference clock signal 604 stops or when the sample count reaches the predetermined count (Mo). During the ON/OFF sequence, the deviation value (δN) updates can employ an Infinite Impulse Response (IIR) filter that combines previous values with new measurements. A flag can control this transition, where a zero indicates ON/OFF sequence operation. The flag being set to zero state can occur naturally when external reference clock signal 604 stops or when the sample count reaches the predetermined count (Mo), but can also be forced by configuring the predetermined count (Mo) to a low value, providing flexibility in sequence control.

In ON/OFF sequence operation, new system error values (N_{ERROR}) per the equation:

$${N}_{ERROR} = \frac{{N}_{T}}{δ N}$$

become available at the ON/OFF rate, specifically after each ON pulse completes. Since this calculation rate has no inherent alignment with stylus frame timing, the system can support immediate on-the-fly updates of the system error values (N_{ERROR}).

A potential edge case can exist where a dithering adjustment (cycle addition or removal) could occur just before a system error value (N_{ERROR}) update, followed by another dithering adjustment based on the new value. This scenario could result in two consecutive corrections of +1 cycles. However, this timing confluence has minimal impact on system operation as it occurs only once at each update transition.

The system can implement an alternative update strategy where system error values (N_{ERROR}) are applied only at stylus frame boundaries, providing a deterministic timing behavior. This next-frame update approach can help maintain more consistent stylus communication timing.

FIG. 10 illustrates a flowchart of an embodiment method 1000 for operating a calibration circuit based on the embodiments disclosed. It is noted that all steps outlined in the method are not necessarily required and can be optional. Further, changes to the arrangement of the steps, removal of one or more steps and path connections, and addition of steps and path connections are similarly contemplated.

At step 1002, the calibration circuit receives the external reference clock signal from the processor and the high-frequency clock signal from the PLL. The circuit opens M sequential calibration windows during this initial phase to establish baseline timing parameters. Within each window, the circuit simultaneously counts cycles of both clock signals, with the external reference count targeting a predetermined value P and the high-frequency count compared against a target count (N_{T}).

The circuit implements a validation check for each calibration window by monitoring whether the external reference clock remains active for P+1% cycles beyond the window closure. This validation ensures measurement integrity by confirming complete processor support throughout the calibration period. The circuit calculates deviation values for validated windows by comparing the actual high-frequency cycle count against the target count (N_{T}). These individual measurements are then averaged across all valid windows to establish initial timing parameters while minimizing the impact of random variations in both clock sources.

At step 1004, following the initial calibration, the system transitions to periodic operation, where the processor alternates between enabling and disabling its reference clock output. During each ON period, the calibration circuit opens new measurement windows while monitoring both clock signals simultaneously. The circuit implements dual termination conditions for these windows when the external reference count reaches P or when the high-frequency count exceeds the target count (N_{T})+2%.

The periodic operation adapts to processor ON/OFF patterns while maintaining continuous calibration capability. This flexibility allows the system to support extended ON periods for multiple sequential measurements and shorter ON pulses for periodic updates while optimizing overall system power consumption through selective reference clock gating.

At step 1006, for each calibration window during periodic operation, the calibration circuit first validates that the external reference clock remained active P+1% cycles beyond window closure. When this validation succeeds, the circuit processes the measurement by calculating a new deviation value based on the difference between the actual and target high-frequency cycle counts.

The new deviation values are processed through an infinite impulse response filter that combines them with previous measurements using a defined weighting coefficient. This filtering approach provides stability while allowing gradual adaptation to changing conditions. The filtered deviation values are then scaled to compute system error values to determine the required timing corrections.

At step 1008, the calibration circuit determines how frequently to adjust the clock divider ratio based on the computed system error values. During normal operation, the divider uses a nominal ratio L to generate the desired output frequency. The circuit periodically modifies this ratio to L+1 or L−1 to compensate for measured frequency errors.

The spacing between ratio adjustments corresponds to the reciprocal of the measured frequency error, providing a smooth correction. This approach maintains precise average frequency alignment while avoiding abrupt timing changes that could disrupt system operation. The circuit can implement additional division ratios beyond L+1 for more precise frequency adjustment.

At step 1010, the timing updates are implemented. In embodiments, the calibration circuit supports two approaches for applying timing updates during system operation. In the first approach, the circuit implements on-the-fly updates where new calibration measurements immediately affect the divider operation. This method allows the system to respond rapidly to timing variations by adjusting the division ratio as soon as new measurements are complete, even within an active stylus communication frame.

In the second approach, the circuit buffers new calibration measurements until they reach stylus frame boundaries. Rather than applying immediate corrections, the buffered measurements accumulate until the current stylus communication frame is completed. Based on these accumulated measurements, the calibration circuit updates the divider ratio at frame boundaries, providing more deterministic timing behavior during active communication sequences.

Based on system requirements, the circuit can be configured to operate in either update mode. The on-the-fly approach prioritizes rapid timing correction at the potential cost of mid-frame adjustments. In contrast, the frame-synchronized approach ensures consistent timing during active communication at the expense of delayed corrections. Both methods maintain continuous calibration operation through processor ON/OFF cycles while preserving the measurement and filtering mechanisms that generate the timing adjustment values.

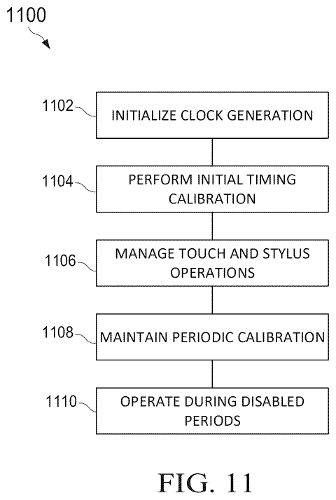

FIG. 11 illustrates a flowchart of embodiment method 1100 for operating a touch controller based on the disclosed embodiments. It is noted that all steps outlined in the method are not necessarily required and can be optional. Further, changes to the arrangement of the steps, removal of one or more steps and path connections, and addition of steps and path connections are similarly contemplated.

At step 1102, the touch controller begins operation by activating its low-frequency RC oscillator, which generates a stable reference signal. This low-frequency output feeds into a phase-locked loop that performs frequency multiplication to produce a high-frequency clock signal. The touch controller also establishes a connection to receive the external reference clock signal that the processor will periodically enable and disable.

The initialization phase establishes multiple clock domains within the touch controller. The high-frequency clock drives the digital core processing, while a divided clock signal controls the analog front-end timing. The touch controller configures its clock divider circuits to generate the appropriate frequencies for each domain while maintaining phase relationships.

At step 1104, during the first enabled period of the external reference clock, the touch controller executes multiple calibration windows to establish baseline timing parameters. In each window, the controller simultaneously counts cycles of the high-frequency clock and external reference clock signals. These measurements capture the timing relationships between the two clock domains while the processor maintains its reference clock output.

The touch controller validates each calibration window by verifying that the external reference clock remains active beyond the measurement period. The controller calculates deviation values for validated windows by comparing actual cycle counts against target values. These individual measurements are averaged to establish stable baseline parameters while minimizing the impact of random variations in either clock source.

The averaged measurements determine initial divider settings that maintain synchronization when the processor later disables its reference clock. These baseline parameters account for systematic frequency offsets between the clock domains while establishing a foundation for subsequent periodic calibration.

At step 1106, the touch controller continuously manages panel operations by performing self-capacitance measurements across the electrode array. Changes in electrode capacitance enable touch detection and stylus position tracking. The controller processes the measurements to maintain accurate position information throughout the operation.

The controller generates uplink signals for stylus communication by modulating voltages on selected panel electrodes. These transmissions carry timing and configuration information to nearby stylus devices. Following each uplink transmission, the controller opens demodulation windows aligned with expected downlink signal timeslots. The controller performs in-phase and quadrature demodulation within these windows to extract data from received stylus signals while maintaining position tracking through continued capacitive measurements. The controller can synchronize its frame based on direct downlink detection and proceed to open demodulation windows aligned with expected downlink signal timeslots.

At step 1108, during subsequent enabled periods of the external reference clock, the touch controller executes new calibration windows to track timing drift. These periodic measurements capture any changes in the timing relationships between clock domains that may have accumulated while the reference clock was disabled. The controller validates each new measurement window using the criteria established during initial calibration.

Valid measurements undergo infinite impulse response filtering, combining new values with previous results using defined weighting coefficients. This filtering approach allows gradual adaptation to changing conditions while maintaining stable operation. The filtered values generate error values that determine how frequently the controller adjusts its clock divider ratios between L and L+1 to maintain synchronization.

The controller supports the immediate application of timing and synchronized updates at frame boundaries. This flexibility allows the system to balance rapid timing correction against consistent communication timing based on operational requirements.

At step 1110, when the processor disables its reference clock output, the touch controller maintains continuous operation using its internally generated clock signals and established timing parameters. The controller continues scanning the touch panel electrodes to track touches and stylus position while preserving the timing relationships needed for reliable stylus communication.

The controller manages power consumption by selectively enabling only the circuits needed for ongoing operation. It maintains touch detection and stylus communication capabilities while operating from its internal clock sources, preserving synchronization until the next enabled period of the external reference clock provides updated timing measurements.

Throughout disabled periods, the controller continues generating uplink signals and processing downlink communications using the timing parameters established through calibration. This maintains consistent operation across enabled and disabled periods while allowing the processor to optimize system power consumption through selective reference clock gating.

A first aspect relates to a system, comprising a touch panel comprising electrodes arranged in a grid pattern; a processor configured to generate a periodically enabled external reference clock; and a touch controller coupled to the touch panel and the processor, the touch controller comprising an oscillator configured to generate a low-frequency reference signal, a phase-locked loop coupled to the oscillator and configured to generate a high-frequency clock signal based on the low-frequency reference signal, a calibration circuit configured to measure timing differences between the high-frequency clock signal and the external reference clock during enabled periods; and compute error values based on the measured timing differences; a clock divider configured to generate timing signals for touch panel operation using a nominal ratio; and adjust the nominal ratio based on the computed error values, and an analog front-end configured to perform capacitive measurements on the electrodes; transmit uplink signals through voltage modulation; and demodulate downlink signals during defined timeslots; or directly synchronize to a downlink signal; and demodulate downlink signals during defined timeslots.

In a first implementation form of the system, according to the first aspect as such, the calibration circuit is further configured to execute multiple measurement windows during an initial enabled period; verify the external reference clock remains active for a predetermined margin after each measurement window; and average timing differences across verified measurement windows to establish baseline timing parameters.

In a second implementation form of the system, according to the first aspect as such or any preceding implementation form of the first aspect, the calibration circuit is further configured to filter new timing differences with previous timing differences using an infinite impulse response filter with a weighting coefficient; and compute the error values based on filtered timing differences.

In a third implementation form of the system, according to the first aspect as such or any preceding implementation form of the first aspect, the clock divider is further configured to use a nominal ratio L during normal operation, where Lis an integer greater than one; periodically adjust between ratios L and L+1 based on the computed error values; and implement division ratios beyond L+1 to enable fractional frequency configurations.

In a fourth implementation form of the system, according to the first aspect as such or any preceding implementation form of the first aspect, the clock divider is further configured to buffer timing updates until stylus communication frame boundaries; or implement buffered updates between frames to maintain consistent timing during active communication.

In a fifth implementation form of the system, according to the first aspect as such or any preceding implementation form of the first aspect, the oscillator comprises a low long-term-jitter RC oscillator configured to maintain frequency stability over extended periods.

In a sixth implementation form of the system, according to the first aspect as such or any preceding implementation form of the first aspect, the analog front-end is further configured to perform self-capacitance and mutual capacitance measurements on the electrodes; detect stylus position through the capacitive measurements; and align demodulation windows with expected downlink signal timeslots based on the timing signals.

A second aspect relates to a method, comprising measuring timing differences between a high-frequency clock signal and a periodically enabled external reference clock during enabled periods; computing error values based on the measured timing differences; generating timing signals for touch panel operation using a nominal ratio; adjusting the nominal ratio based on the computed error values; performing capacitive measurements on touch panel electrodes; transmitting uplink signals through voltage modulation; and demodulating downlink signals during defined timeslots; or directly synchronizing to a downlink signal; and demodulating downlink signals during defined timeslot.

In a first implementation form of the method, according to the second aspect as such, the method further comprising executing multiple measurement windows during an initial enabled period; verifying the external reference clock remains active for a predetermined margin after each measurement window; and averaging timing differences across verified measurement windows to establish baseline timing parameters.

In a second implementation form of the method, according to the second aspect as such or any preceding implementation form of the second aspect, the method further comprising filtering new timing differences with previous timing differences using an infinite impulse response filter with a weighting coefficient; and computing the error values based on filtered timing differences.

In a third implementation form of the method, according to the second aspect as such or any preceding implementation form of the second aspect, adjusting the nominal ratio comprises using a nominal ratio L during normal operation, where L is an integer greater than one; periodically adjusting between ratios L and L±1 based on the computed error values; and implement division ratios beyond L±1 to enable fractional frequency configurations.

In a fourth implementation form of the method, according to the second aspect as such or any preceding implementation form of the second aspect, the method further comprising buffering timing updates until stylus communication frame boundaries; or implementing buffered updates between frames to maintain consistent timing during active communication.

A third aspect relates to a circuit, comprising a first counter configured to count cycles of an external reference clock and assert signals at predetermined count thresholds; a second counter configured to count cycles of a high-frequency clock and provide cycle count values; a first logic gate coupled to receive a reset signal and the external reference clock; a second logic gate coupled to outputs of the first counter and the second counter and configured to generate a window closure signal; a latch coupled to the second counter and configured to capture cycle count values in response to the window closure signal; and provide captured values for computing timing differences; and a divider circuit configured to receive computed timing differences; and adjust division ratios based on the timing differences.

In a first implementation form of the circuit, according to the third aspect as such, the control logic is further configured to execute multiple measurement windows during an initial enabled period; verify the external reference clock remains active for a predetermined margin after each window; and average timing differences across verified windows to establish baseline parameters.

In a second implementation form of the circuit, according to the third aspect as such or any preceding implementation form of the third aspect, the control logic is further configured to filter new timing differences with previous timing differences using an infinite impulse response filter with a weighting coefficient; and compute the error values based on filtered timing differences.

In a third implementation form of the circuit, according to the third aspect as such or any preceding implementation form of the third aspect, the window control logic is configured to terminate measurement windows in response to the first counter reaching a predetermined count or the second counter exceeding a target count plus margin.

In a fourth implementation form of the circuit, according to the third aspect as such or any preceding implementation form of the third aspect, the circuit further comprising an initialization logic including a flip-flop coupled to receive a reset signal and the external reference clock; and logic gates configured to generate synchronized reset signals.

In a fifth implementation form of the circuit, according to the third aspect as such or any preceding implementation form of the third aspect, the control logic is further configured to buffer timing updates until stylus communication frame boundaries; or implement buffered updates between frames to maintain consistent timing.

In a sixth implementation form of the circuit, according to the third aspect as such or any preceding implementation form of the third aspect, the first counter is further configured to assert a first signal upon reaching a predetermined count; and assert a second signal upon reaching the predetermined count plus margin.

In a seventh implementation form of the circuit, according to the third aspect as such or any preceding implementation form of the third aspect, the second counter is further configured to provide continuous cycle count values to the latch; and assert a signal upon exceeding a target count plus margin.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

1. A system, comprising:
a touch panel comprising electrodes arranged in a grid pattern;
a processor configured to generate a periodically enabled external reference clock; and
a touch controller coupled to the touch panel and the processor, the touch controller comprising:
an oscillator configured to generate a low-frequency reference signal,
a phase-locked loop coupled to the oscillator and configured to generate a high-frequency clock signal based on the low-frequency reference signal,
a calibration circuit configured to:
measure timing differences between the high-frequency clock signal and the external reference clock during enabled periods; and
compute error values based on the measured timing differences;
a clock divider configured to:
generate timing signals for touch panel operation using a nominal ratio; and
adjust the nominal ratio based on the computed error values, and
an analog front-end configured to:
perform capacitive measurements on the electrodes;
transmit uplink signals through voltage modulation in a first operating mode;
demodulate downlink signals during defined timeslots in the first operating mode;
directly synchronize to a downlink signal in a second operating mode; and
demodulate downlink signals during defined timeslots in the second operating mode.

2. The system of claim 1, wherein the calibration circuit is further configured to:
execute multiple measurement windows during an initial enabled period;
verify the external reference clock remains active for a predetermined margin after each measurement window; and
average timing differences across verified measurement windows to establish baseline timing parameters.

3. The system of claim 1, wherein the calibration circuit is further configured to:
filter new timing differences with previous timing differences using an infinite impulse response filter with a weighting coefficient; and
compute the error values based on filtered timing differences.

4. The system of claim 1, wherein the clock divider is further configured to:
use a nominal ratio L during normal operation, where L is an integer greater than one;
periodically adjust between ratios L and L±1 based on the computed error values; and
implement division ratios beyond L±1 to enable fractional frequency configurations.

5. The system of claim 1, wherein the clock divider is further configured to:
buffer timing updates until stylus communication frame boundaries; or
implement buffered updates between frames to maintain consistent timing during active communication.

6. The system of claim 1, wherein the oscillator comprises a low long-term-jitter RC oscillator configured to maintain frequency stability over extended periods.

7. The system of claim 1, wherein the analog front-end is further configured to:
perform self-capacitance and mutual capacitance measurements on the electrodes;
detect stylus position through the capacitive measurements; and
align demodulation windows with expected downlink signal timeslots based on the timing signals.

8. A method, comprising:
measuring timing differences between a high-frequency clock signal and a periodically enabled external reference clock during enabled periods;
computing error values based on the measured timing differences;
generating timing signals for touch panel operation using a nominal ratio;
adjusting the nominal ratio based on the computed error values;
performing capacitive measurements on touch panel electrodes;
transmitting uplink signals through voltage modulation in a first operating mode;
demodulating downlink signals during defined timeslots in the first operating mode;
directly synchronizing to a downlink signal in a second operating mode; and
demodulating downlink signals during defined timeslots in the second operating mode.

9. The method of claim 8, further comprising:
executing multiple measurement windows during an initial enabled period;
verifying the external reference clock remains active for a predetermined margin after each measurement window; and
averaging timing differences across verified measurement windows to establish baseline timing parameters.

10. The method of claim 8, further comprising:
filtering new timing differences with previous timing differences using an infinite impulse response filter with a weighting coefficient; and
computing the error values based on filtered timing differences.

11. The method of claim 8, wherein adjusting the nominal ratio comprises:
using a nominal ratio L during normal operation, where L is an integer greater than one;
periodically adjusting between ratios L and L±1 based on the computed error values; and
implement division ratios beyond L+1 to enable fractional frequency configurations.

12. The method of claim 8, further comprising:
buffering timing updates until stylus communication frame boundaries; or
implementing buffered updates between frames to maintain consistent timing during active communication.

13. A circuit, comprising:
a first counter configured to count cycles of an external reference clock and assert signals at predetermined count thresholds;
a second counter configured to count cycles of a high-frequency clock and provide cycle count values;
a first logic gate configured to receive a reset signal and the external reference clock;
a second logic gate coupled to outputs of the first counter and the second counter and configured to generate a window closure signal;
a latch coupled to the second counter and configured to:
capture cycle count values in response to the window closure signal; and
provide captured values for computing timing differences; and
a divider circuit configured to:
receive computed timing differences; and
adjust division ratios based on the timing differences.

14. The circuit of claim 13, wherein the control logic is further configured to:
execute multiple measurement windows during an initial enabled period;
verify the external reference clock remains active for a predetermined margin after each window; and
average timing differences across verified windows to establish baseline parameters.

15. The circuit of claim 13, wherein the control logic is further configured to:
filter new timing differences with previous timing differences using an infinite impulse response filter with a weighting coefficient; and
compute the error values based on filtered timing differences.

16. The circuit of claim 13, wherein the window control logic is configured to terminate measurement windows in response to the first counter reaching a predetermined count or the second counter exceeding a target count plus margin.

17. The circuit of claim 13, further comprising an initialization logic including:
a flip-flop coupled to receive a reset signal and the external reference clock; and
logic gates configured to generate synchronized reset signals.

18. The circuit of claim 13, wherein the control logic is further configured to:
buffer timing updates until stylus communication frame boundaries; or
implement buffered updates between frames to maintain consistent timing.

19. The circuit of claim 13, wherein the first counter is further configured to:
assert a first signal upon reaching a predetermined count; and
assert a second signal upon reaching the predetermined count plus margin.

20. The circuit of claim 13, wherein the second counter is further configured to:
provide continuous cycle count values to the latch; and
assert a signal upon exceeding a target count plus margin.
